(19) United States
(12) Patent Application Publication
(10) Pub. No.: US 2018/0232834 A1
(43) Pub. Date: Aug. 16, 2018

(54) SUSTAINABLE SOCIAL SECURITY SYSTEM

(71) Applicant: Sreejith VIJAYARAJ, Calicut (IN)

(72) Inventor: Sreejith VIJAYARAJ, Calicut (IN)

(21) Appl. No.: 15/751,473

(22) PCT Filed: Aug. 10, 2016
(86) PCT No.: PCT/IB2016/054800

§ 371 Date: Feb. 9, 2018

(30) Foreign Application Priority Data
Aug. 10, 2015 (IN) 4156/CHE/2015

(51) Int. Cl. G06Q 50/26; G06Q 40/08

(52) U.S. Cl. CPC G06Q 50/26; G06Q 20/36; G06Q 40/08

(57) ABSTRACT

A sustainable social security system(100) or ‘SeQued’ can be defined as a Web/Mobile based application (through a front end secured login access) intended primarily to act as a facilitation platform that provide a holistic & sustainable solution to 360 degree Health protection & Social Security needs of the people” which is optimally structured for additional wealth or value enhancement proportionate to the customer's ‘spend transactions’ for various shopping needs at offline and online stores using the payment modes provided under this platform (Debit Card/Credit Card/Pre-paid Card or Mobile/Web Digital Wallet).

### TECHNICAL FIELD

The present invention generally relates to social security systems. More particularly, the invention, disclosed herein, relates to a sustainable social security system designed with an objective to provide a viable Social Security option especially for people of developing countries like India, where government driven social security measures are ineffective and woefully inadequate. The utility model integrates (1) Sustainable model of Preventive or Proactive Healthcare Services, (2) Health or Medical Insurance, (3) Life Insurance (which may include death & disability insurance) and (4) Retirement or Pension plans on a single service delivery platform with an objective to create a “unified 360 degree voluntary (or contributory) Social Security & Health Protection Scheme” (VSSHPS), Or “Sustainable Health Assurance & Social Security Investment Platform (SHASSIP)”, hereinafter referred in this document as “SecQued”, suitable for the subscription of employees of the corporate sector, organized sectors, unorganized sectors, and individuals.

### BACKGROUND

Social Security is generally regarded as a subject matter of “direct responsibility of the Government”. Unless the country is rich enough, (which is not the case of most nations today); there are hardly any significant measures of proper state driven social security initiatives seen across the world today. Further, existing solutions are today restricted within the workforce of “organized sector” while, sadly, over 80% of most of the countries employable populations are occupied in ‘unorganized sectors. In most of the developing countries, penetration of insurance, pension and healthcare services are extremely low compared to developed countries. With ever increasing rise in cost of living coupled with the rapid growth of lifestyle diseases across the world, people become poorer year on year because of unaffordable healthcare expenditure and lack of government sponsored social security & welfare measures.

An ideal Social Security is not about planning for or just providing for reactive contingencies such as health coverage, life insurance coverage and retirement income or pension assurance. What needs to be understood in the right perspective is the fact that “no measure of such social security will be effective & sustainable in the long run” unless the core aspect of “lifestyle disease Risks” or Non-communicable disease risk are first addressed. Without a proper check & balance of the “health risks aspects of the people, “both Health Insurance and Life Insurance which are two major elements of “social security’ will become unaffordable and unsustainable in the long run. So, what we need is essentially an integrated approach covering Health Insurance, Life Insurance, and Retirement Solution along with a “Sustainable model of preventive or proactive healthcare program” focused on eliminating or preventing or managing the world's biggest menace called—“Lifestyle Diseases”.

In short, a proper 360 degree Personal Social Security can be defined as—“The need of a person to rightfully live healthy (Proactive Healthcare needs), failure of which, he should be secured or guarded against the financial burden of his hospitalization & treatments (Health Insurance needs), failure of which, the surviving family members should be secured or guarded against the possible financial loss of the key bread winner of the family on account of his untimely demise (Life Insurance needs) and at the survival phase of all these, the larger need of the individual to gracefully age and maintain a healthy and financially secured retirement life—(Retirement Income/Pension needs)

As of now, cash backs or cash back points are generally utilised or redeemed by the customers again to buy additional goods and services in general and not streamlined or dedicated towards a sustainable social security or health assurance program. The larger potential or power of optimally channelizing “Cash Back or other monetization benefits” accrued out of a person's “Spend transactions” in sustaining & enhancing his/her long-term wealth creation under his retirement or personal pension plans has not been specifically identified, modelled, utilized and programmed by any individuals or entities as part of either a total or partial social security investment program/platform. Similarly, the larger potential power of optimally channelizing “Cash Back or other monetization benefits” in sustaining & enhancing a person's long-term health insurance & life insurance or any such systematic investment program (SIP) in mutual funds or unit linked or non-unit linked insurance needs has not been specifically identified, utilized and programmed by any entities as part of either a total or a partial social security investment program/platform.

As of now, we do not have a proper facilitation platform that integrates all the above mentioned 4 major elements under a unified access point. Government collects taxes and other levies from the people which are then apportioned across the State's various developmental & welfare activities. But at an individual's level, it is difficult to make a direct correlation of such welfare accruals to a person specifically in relation to his/her social security aspects such as healthcare, health insurance, life insurance & retirement earnings. Sustainability is the foundation for the success of any social security investment program. Challenge is more when it comes to maintain persistency of regular and disciplined investments though small in nature, for long term tenure. There needs to be a proper “Incentivization” to promote this behavior.

One of the definite actions every individual performs invariably to make his living is to “spend the money” that he/she earns, the outer limit of which, is only defined by the quantum of his earnings. Every third person in an Indian city today is a youth. the median individual in India will soon be 29 years, very likely a city-dweller, making it the youngest country in the world. By 2020, India is set to become the world's youngest country with 64 percent of its population in the working age group. This invariably emphasizes the need to have in place a proper sustainable solution for individual's health assurance & social security needs. It will be highly unaffordable and impractical for a Government of a developing nation like India to make an adequate budget allocation to cover these requirements. Hence, we need to evaluate the alternative solutions to address this critical need.

Non-Communicable/Lifestyle disease, growing at an alarmingly epidemic proportion, accounts for over 70% of deaths worldwide. The World Health Organization (WHO) has identified India as one of the nations that is going to have most of the lifestyle disorders soon accounting for over 75% of total healthcare spent, making health insurance & Healthcare services unaffordable. Over 70% of healthcare cost is met by the families out of their own pocket. More and more people are pushed into poverty every year causing gross welfare loss of over 12% of India's GDP translating into approximately $250 billion a year! Currently, only 17% of the country's population is covered by some means of health insurance; of which close to 90% is Government sponsored & Group schemes. The country's total insurance penetration is way below the global average (3.9% of GDP—Both Life & General Insurance). Of the 400 million working age Indians, less than 12% are covered by some form of retirement benefit scheme. Moreover, 93% of the working class falls in unorganized sectors with an approx. Number of around 370 million.

Hence, there is a long felt but unresolved need for a dedicated and integrated system or platform that combines all elements of an ideal social security investment needs and offer 360 degree Sustainable Social Security solution for an individual which is optimally designed and structured for additional ‘free or bonus earnings’ proportionate to the customer's ‘spend transactions’ for his/her various shopping needs at offline and online stores; using one or more of the payment modes provided under this platform (Debit Card/Credit Card/Pre-paid Card or Mobile/Web Digital Wallet) and productively routed back to the customer towards his social security wealth enhancement.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended to determine the scope of the claimed subject matter.

The invention, disclosed herein, addresses the above-mentioned need for a dedicated and integrated system or platform that combines all elements of an ideal social security investment needs and offer 360 degree Sustainable Social Security solution for an individual which is optimally designed and structured for additional ‘free or bonus earnings’ proportionate to the customer's ‘spend transactions’ for his/her various shopping needs at offline and online stores; using one or more of the payment modes provided under this platform (Debit Card/Credit Card/Pre-paid Card or Mobile/Web Digital Wallet) and productively routed back to the customer towards his social security wealth enhancement.

‘SeQued’ is defined as a Web/Mobile based application (through a front end secured login access) intended primarily to act as a facilitation platform that provide a holistic & sustainable solution to 360 degree Health protection & Social Security needs of the people” which is optimally structured for additional wealth or value enhancement proportionate to the customer's ‘spend transactions’ for various shopping needs at offline and online stores using the payment modes provided under this platform (Debit Card/Credit Card/Pre-paid Card or Mobile/Web Digital Wallet). “SecQued” in other words is a “self-imposed levy/tax on a person, voluntarily thrust upon himself, the complete benefits of which can be directly attributable, identifiable and quantifiable against his own welfare measures covering his proactive healthcare needs, health & life insurance needs and retirement needs.”

The solution needs to be contiguously offered in concert with a Bank or Financial Institution to enable value enhancement, easy payment transaction & administration process. A co-branded (bank & the solution provider) debit card or prepaid card (Like Visa, Master card etc.,) with or without a credit line or a credit card itself to be issued to the individual subscribers of the scheme by the bank through the solution provider “SecQued”. The utility model also helps an individual diligently deploy this card for promptly making periodic subscription pay outs (for maintaining the healthcare service pay out, health & life insurance premiums and investments in approved retirement plans) whilst also using the card for regular shopping. Special Cash back facility is provided on this card through the solution provider's affiliated vendors on selected shopping avenues and merchandise. A part or full value of such ‘cash back credits’ to be used to re-invest or “top up” the insurance or pension program originally granted to the individual as part of the scheme. This helps in further enhancing the returns or value of the investment of the subscriber.

‘SecQued’ creatively incentivizes these spending and generates a parallel funnel with “Cash back or Other Monetization programs at the merchant's end” which is then productively channelized and utilized to enhance the wealth of the person (such as re-investment or ‘top up” in his personal pension plan) or to maintain/enhance healthcare services or health or life insurance coverage brought under the unified platform. The key specifications include:
Networking Healthcare services, Insurance/Pension products and certain Banking services (Credit/Debit/Prepaid cards and/or Digital Wallets) in a single unified digital technology platform to offer 360 degree Sustainable Social Security solution for a customer which is optimally structured for additional wealth enhancement proportionate to the customer's ‘spend transactions’ for various shopping needs at offline and online stores using the payment modes provided under this platform “SecQeued” Co-branded Debit Card/Credit Card/Pre-paid Card or Mobile/Web Digital Wallet).
Optimal channelization & productive usage of cash back incentives & other monetizable incentives offered by various merchants, manufactures, banks and other related entities to a product/service sale to an end buyer/user/customer exclusively into his social security investment portfolios, primarily for enhancing the kitty of retirement wealth or for securing additional health & life insurance coverage.
Systematic Investment Plan for a person's “Social Security Investment needs” (SIP in Social Security Investments). By investing a small sum periodically (monthly/quarterly/half yearly or yearly), an individual can create sufficient pool to secure his healthcare, health insurance, life Insurance and retirement needs.
Unified tracking and monitoring solution for an individual's health & healthcare aspects, Health Insurance details, Life Insurance details/Retirement Solution details and other Financial Investment details (optional)—This comprehensive cloud based digital platform (Web Application or Mobile Application) enables personalized secured tracking and monitoring of all these critical aspects of a person and thus helps him to lead a more secured &stress-free life.
Well defined and sustainable model of “Social Security”—Making ‘continual and structured preventive healthcare’ an integral part in the definition of 360-degree social security to ensure that the complete elements of Social Security are sustainable in the long run. Preventive healthcare forms a solid foundation to minimize incidence of higher claims under Health Insurance and Life Insurance cover and thus makes both these insurance coverages affordable with stable premiums for the subscribers.
Built-in solution to ensure life time sustainability—Online self-sustainable utility model coupled with periodical offline follow-up services for healthcare, insurance and pension services helps a person to perform timely actions and thus keep all his healthcare and social security programs renewed and updated
Best fitment solution for Corporate/Industrial Employee's Social Security needs: Employers can structure the investments in the employee's compensation packages and thus offer the “total Social Security coverage” to its employees with a single window coordination and processing.
   The business entities or authorised agents can use this platform to integrate and link their affiliated insurance/pension programs as well as their affiliated Debit/Credit/prepaid cards or digital wallet partners and then up-sell/cross sell the solution (SecQued) to their captive customers or use this tool/platform to target fresh client acquisition for their business. This will be done under a revenue share agreement for the card transaction fee and other permissible revenue accruals of the business entity with the promoter/developer and marketer of this platform.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods, components, and structures disclosed herein. The description of a method step or a component or a structure referenced by a numeral in a drawing is applicable to the description of that method step or component or structure shown by that same numeral in any subsequent drawing herein.

FIG. 1 exemplarily illustrates a process flow depicting elements of the sustainable social security system.

FIG. 2 exemplarily illustrates a process flow depicting an individual subscribing to the sustainable social security system.

FIG. 3 exemplarily illustrates a process flow depicting an individual subscribing to the sustainable social security system.

FIG. 4 exemplarily illustrates a comparison chart comparing present day social security schemes and facilities provided or offered in general by most of the employers with that of the sustainable social security system.

### DESCRIPTION OF THE PREFERRED EMBODIMENT

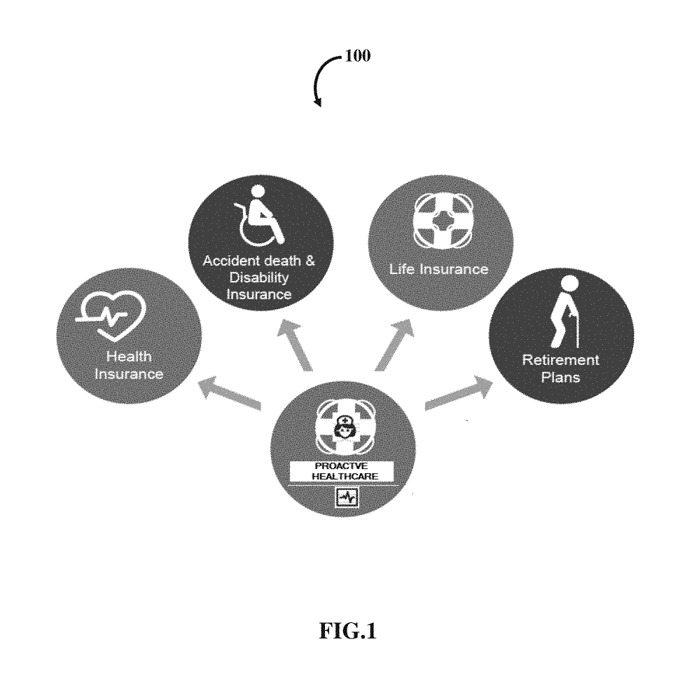

FIG. 1 exemplarily illustrates a process flow depicting elements of the sustainable social security system 100. The process flow depicts the elements of Voluntary (or contributory) “Social Security & Health Protection Scheme” (VSSHPS), which, may alternatively be referred (among many other possible combination terminologies) to as “Sustainable Health Assurance & Social Security Investment Platform (SHASSIP)” and proposed to be deployed under a protected brand name. “SecQued”.

‘SeQued’ is defined as a Web/Mobile based application (through a front end secured login access) intended primarily to act as a facilitation platform that provide a holistic & sustainable solution to 360 degree Health protection & Social Security needs of the people” which is optimally structured for additional wealth or value enhancement proportionate to the customer's ‘spend transactions’ for various shopping needs at offline and online stores using the payment modes provided under this platform (Debit Card/Credit Card/Pre-paid Card or Mobile/Web Digital Wallet). “SecQued” in other words is a “self-imposed levy/tax on a person, voluntarily thrust upon himself, the complete benefits of which can be directly attributable, identifiable and quantifiable against his own welfare measures covering his proactive healthcare needs, health & life insurance needs and retirement needs.”

The solution needs to be contiguously offered in concert with a Bank or Financial Institution to enable value enhancement, easy payment transaction & administration process. A co-branded (bank & the solution provider) debit card or prepaid card (Like Visa, Master card etc.,) with or without a credit line or a credit card itself to be issued to the individual subscribers of the scheme by the bank through the solution provider “SecQued”. The utility model also helps an individual diligently deploy this card for promptly making periodic subscription pay outs (for maintaining the healthcare service pay out, health & life insurance premiums and investments in approved retirement plans) whilst also using the card for regular shopping. Special Cash back facility is provided on this card through the solution provider's affiliated vendors on selected shopping avenues and merchandise. A part or full value of such ‘cash back credits’ to be used to re-invest or “top up” the insurance or pension program originally granted to the individual as part of the scheme. This helps in further enhancing the returns or value of the investment of the subscriber.

‘SecQued’ creatively incentivizes these spending and generates a parallel funnel with “Cash back or Other Monetization programs at the merchant's end” which is then productively channelized and utilized to enhance the wealth of the person (such as re-investment or ‘top up” in his personal pension plan) or to maintain/enhance healthcare services or health or life insurance coverage brought under the unified platform. The key specifications include:
Networking Healthcare services, Insurance/Pension products and certain Banking services (Credit/Debit/Prepaid cards and/or Digital Wallets) in a single unified digital technology platform to offer 360 degree Sustainable Social Security solution for a customer which is optimally structured for additional wealth enhancement proportionate to the customer's ‘spend transactions’ for various shopping needs at offline and online stores using the payment modes provided under this platform “SecQeued” Co-branded Debit Card/Credit Card/Pre-paid Card or Mobile/Web Digital Wallet).
Optimal channelization & productive usage of cash back incentives & other monetizable incentives offered by various merchants, manufactures, banks and other related entities to a product/service sale to an end buyer/user/customer exclusively into his social security investment portfolios, primarily for enhancing the kitty of retirement wealth or for securing additional health & life insurance coverage.
Systematic Investment Plan for a person's “Social Security Investment needs” (SIP in Social Security Investments). By investing a small sum periodically (monthly/quarterly/half yearly or yearly), an individual can create sufficient pool to secure his healthcare, health insurance, life Insurance and retirement needs.
Unified tracking and monitoring solution for an individual's health & healthcare aspects, Health Insurance details, Life Insurance details/Retirement Solution details and other Financial Investment details (optional)—This comprehensive cloud based digital platform (Web Application or Mobile Application) enables personalized secured tracking and monitoring of all these critical aspects of a person and thus helps him to lead a more secured &stress-free life.
Well defined and sustainable model of “Social Security”—Making ‘continual and structured preventive healthcare’ an integral part in the definition of 360-degree social security to ensure that the complete elements of Social Security are sustainable in the long run. Preventive healthcare forms a solid foundation to minimize incidence of higher claims under Health Insurance and Life Insurance cover and thus makes both these insurance coverages affordable with stable premiums for the subscribers.
Built-in solution to ensure life time sustainability—Online self-sustainable utility model coupled with periodical offline follow-up services for healthcare, insurance and pension services helps a person to perform timely actions and thus keep all his healthcare and social security programs renewed and updated
Best fitment solution for Corporate/Industrial Employee's Social Security needs: Employers can structure the investments in the employee's compensation packages and thus offer the “total Social Security coverage” to its employees with a single window coordination and processing.
The business entities or authorised agents can use this platform to integrate and link their affiliated insurance/pension programs as well as their affiliated Debit/Credit/prepaid cards or digital wallet partners and then up-sell/cross sell the solution (SecQued) to their captive customers or use this tool/platform to target fresh client acquisition for their business. This will be done under a revenue share agreement for the card transaction fee and other permissible revenue accruals of the business entity with the promoter/developer and marketer of this platform.

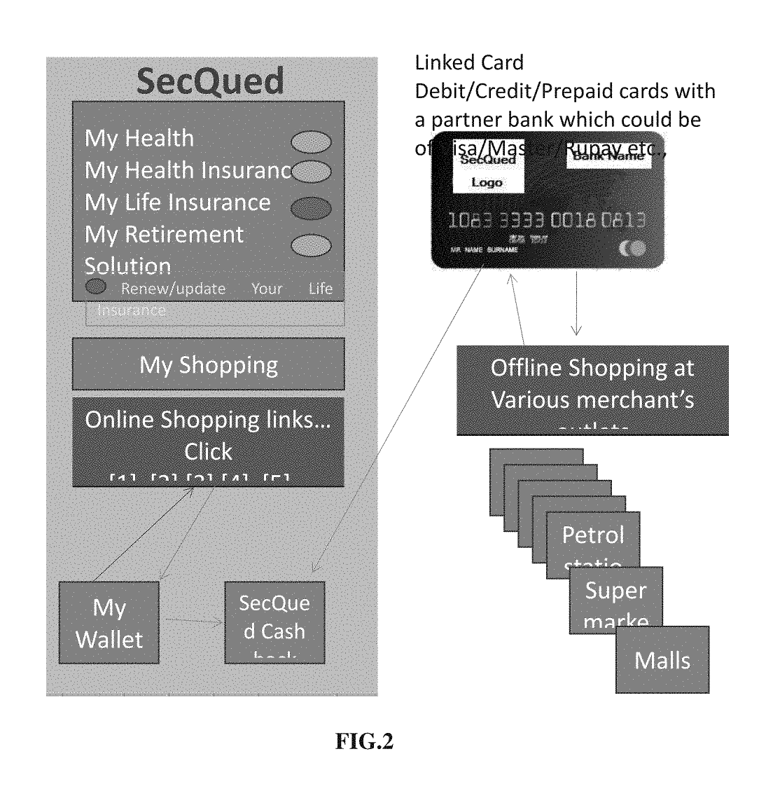

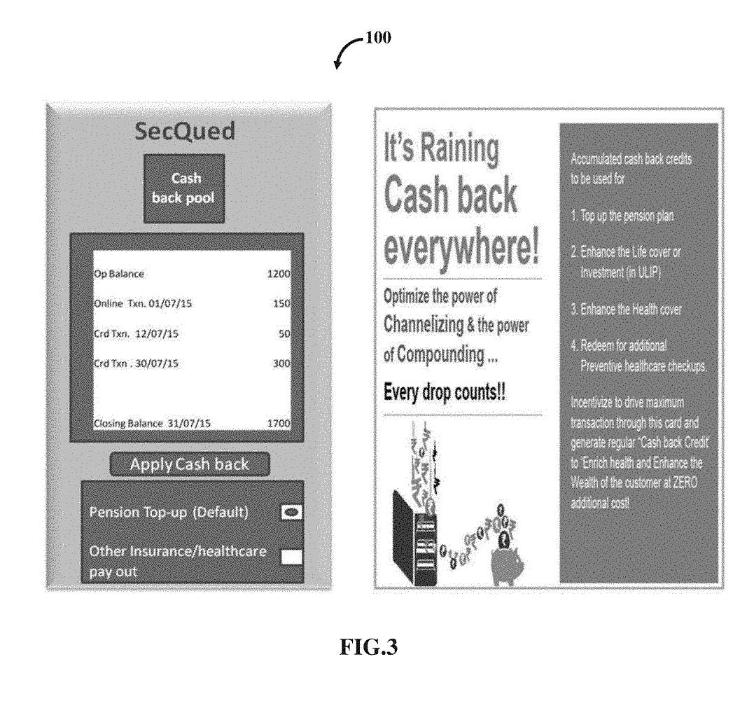

FIG. 2 exemplarily illustrates a process flow depicting an individual subscribing to the sustainable social security system. FIG. 3 exemplarily illustrates a process flow depicting an individual subscribing to the sustainable social security system. Customer opts for the platform—“SecQued” through any Banks/Insurance brokers or Insurance Corporate/Retail agents. Customer downloads the ‘SecQued Application Software, (Mobile or Web App) completes his registration process by himself or through his licensed agent. Next, the customer chooses his/her desired plan for “Preventive Healthcare” from the given options followed by choosing his plan for Health Insurance, Life Insurance & Pension program. The customer then makes initial payment for the total services which is allocated to each of the verticals (Healthcare company, health insurance company, life insurance company and pension management company). Once the customer, subscribes to the “SecQued” co-branded Cash Back Cards—Debit/Credit card or Prepaid card subject to the necessary banking KYC & other eligibility norms, the customer gets his/her Card issued by the bank after due diligence and starts using the cards for shopping & other payment needs & also provide a mandate for regular subscription pay out for “SecQued” through this card.

Cash back or Cash back points earned through shopping with the card or digital wallet can be tracked in the “SecQued mobile/Web App platform. The healthcare partner coordinates for the execution of his “Preventive healthcare” program. The Health, Life & Pension policies are processed and dispatched to him. All details of these policies can be tracked through the platform—“SecQued”. The timely reminder for premium pay out and healthcare maintenance alerted by the SecQued App and, parallel offline service support ensured by the back-end team at SecQued. Cash back points, once reaches a minimum quantum, get transferred to the pre-determined usage such as top up or re-investment in pension plan or payment of Insurance premium pay outs. The sustainable social security system 100 has a facility to make digital payment through the app. Cash can be loaded to the digital wallet or to the Card for shopping.

Direct benefits to customers or subscribers of this platform include excellent ‘effective and viable alternative for a personal social security solution’ against the present woefully designed or limited access government sponsored schemes. The entire investments made by the person are presently fully exempt from Tax in India, under Sec. 80D & 80C as per the Indian Income Tax Act. Robust & self-sustainable Social Security Solution. Customers receive easy access to a comprehensive solution for personal health & social security scheme that can be tailor made or customized to individual customer needs. Single point service interface that connects to multiple point of services at the back end through a unified web/mobile application software utility. Easy and quick tracking, monitoring the healthcare aspects, insurance & pension schemes with an offline service support at the backend. Single point data repository. Huge possibilities for enhancing his wealth by opting transactions through ‘SecQued’ cash back card with affiliated merchants. A lifetime free-bonus earning towards wealth enhancement. Encourages disciplined investment behavior—Promote stress free living. Best fitment solution for the employees of any organizations where, the employer does the facilitation of this program through salary deductions or such pay outs are sponsored fully or partly by the employer as part of the organization's employee welfare program. Dematerializes cash transactions and hence able to maintain good accountability of expenses. A real boon for the employees of unorganized sectors, professionals, and self-employed who generally do not have easy access to any such structured solution unlike the people working in organized sectors.

Benefits to the partnering banks/financial institutions include enormous potential for new customer acquisition. Excellent revenue potential via card transaction fee, Interests, float etc. Parallel customer acquisition for the bank's group companies—Life & Health Insurance. Claim Risk potential for Insurance (Health & Life) minimized to the best extent as each customer's health is managed on a lifetime sustainable basis. Easy up-sell for bank's pre-approved customers (as a Supplementary card). Cross-sell opportunities for all Savings Account holders of the Bank. Good opportunity to acquire more corporate salary accounts.

Benefits to the employers is achieved when the program is run as part of the organization's employee welfare scheme or fully or partially sponsored by the employer. Single channel management for the complete health & welfare schemes of the employees of the organization. Employer can participate as a contributory to this fund in full or part (like employee provident fund). Product can be very well integrated with the employee compensation structure. Group underwriting process can be initiated to bring down premiums of health &life cover substantially. Employer can use the card loading facility for medical reimbursement and other perquisites and reimbursements offered to the employee and can provide optimal tax benefit to the employee.

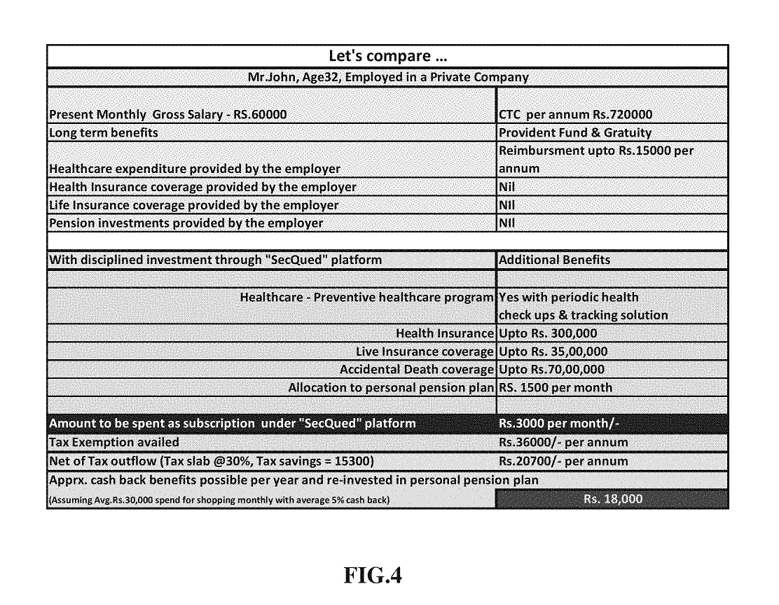

FIG. 4 exemplarily illustrates a comparison chart comparing present day social security schemes and facilities provided or offered in general by most of the employers with that of the sustainable social security system 100. One of the huge responsibilities of Government to its people is alternatively managed and taken care through this highly structured and scientifically designed program. Huge positive implication on the government budgets & economic growth indexes. The sustainable social security system 100 encourages long term savings of the people and thus boosts economic growth. The sustainable social security system 100 discourages “Cash transactions” and promotes mobile/digital and card transactions thus reducing tax avoidance & money laundering possibilities. Long term investment schemes initiated by Government (like National Pension Systems of India) are promoted through this platform. Further, the sustainable social security system 100 promotes huge awareness on the need for availing structured and sustainable preventive healthcare services. People become healthier& wealthy. Government need to provide lesser budgets for contingencies. Government can roll out this scheme for the entire Government employees and thus reduce the burden of direct investment on this front. Government can channelize tax incentive program and other benefits to encourage investment by people through this platform. Dematerializes currency and reduces the need for currency notes circulations. This solution is directly beneficial for adoption by any developing countries where, proper government driven social security schemes are unavailable or inadequate or where the existing such provisions are designed unscientifically and hence not optimally reaching out to the needy. There is a much bigger scope of this solution, if meaningfully adopted by the developed countries where already government sponsored social security initiatives are in place. These nations can channelize more incentives to traders, manufactures and service providers to promote “Cash Back” under this scheme so that the government ends up spending much lesser on the “Retirement investment & Insurance maintenance Kitty”. Thus, the Governments can free more resources to be allocated for other economic developmental activities.

The foregoing examples have been provided merely for the purpose of explanation and are in no way to be construed as limiting of the sustainable social security system100, disclosed herein. While the sustainable social security system100 has been described with reference to various embodiments, it is understood that the words, which have been used herein, are words of description and illustration, rather than words of limitation. Further, although the sustainable social security system100 has been described herein with reference to particular means, materials, and embodiments, the sustainable social security system100 is not intended to be limited to the particulars disclosed herein; rather, the sustainable social security system100 extends to all functionally equivalent structures, methods and uses, such as are within the scope of the invention. Although there has been shown and described the preferred embodiment of the present invention, it will be readily apparent to those skilled in the art that modifications may be made thereto.

1. A confluence of a unique art, a customized method, effective and viable manner coupled with innovative industrial applications and digital technology to set up a utilitarian platform/solution/system/model illustrated under FIG. 1 with capability to provide exclusive, dedicated and integrated solutions illustrated under FIG. 2 which combines all elements for an ideal social security system that offers a Three Hundred and Sixty Degree perspective and solution with further spin offs of earning concessions and money back advantages on spending illustrated under FIG. 3 with a competitive advantage over the prior art that is illustrated in FIG. 4.

2. The confluence of a unique Art, a customized method, effective and viable manner coupled with innovative industrial applications and digital technology to set up a utilitarian platform/solution/system/model as in claim 1, that facilitates and links existing Business to Business (B2B) capabilties and strengths to create synergies in business operations for these entities and customization of their existing products and services with spin offs of new products and services that can be marketed or offered as a B2B solution to Banks, Insurance brokers, Corporates & retail insurance agents and other Financial Service entities for them to promote the same to the end customers as B2C (Business to Customers)

3. The confluence of a unique Art, a customized method, effective and viable manner coupled with innovative industrial applications and digital technology to set up a utilitarian platform/solution/system/model as in claim 1, that enables ‘utilisation concept, methods & process’ of “Spend Incentives” such as Cash backs & other monetization plans” as illustrated in FIG. 3 to deliver more benefits productively to sustain & enhance health & wealth investments offered under a dedicated social security solution platform as comparatively illustrated in FIG. 4.

4. A confluence of a unique Art, a customized method, effective and viable manner coupled with innovative industrial applications and digital technology to set up a utilitarian platform/solution/system/model that combines any one of or all of or combinations of the four essential elements of Social Security programs (ie., (1) Preventive Healthcare, (2) Health Insurance, (3) Life Insurance & (4) Retirement/Pension investment solutions) with certain banking or financial services' products (Credit/Debit/Prepaid cards and/or Digital Wallets), and defines a utilisation method & process' of the “Spend Incentives” such as Cash backs and or other monetization credits” earned through the use of these cards or wallets for both online or offline shopping, for the application or utilisation directly into, either for the sustenance of insurance or pension plans (towards payment of regular premiums or installments due) or for the additional investment or enhancement of the wealth accumulation under such Insurance or retirement plans (other than that of the periodical premium or installments—say, additional top-up investments) availed by the customer form any government owned insurance or pension management entities (for e.g., National Pension System in India) or from other private insurance or pension business entities.
